(19) United States
(12) Patent Application Publication
(10) Pub. No.: US 2013/0307790 A1
(43) Pub. Date: Nov. 21, 2013

(54) Methods And Apparatus For Device Control

(71) Applicants: Urho KONTTORI, Helsinki (FI); Petteri Kauhanen, Espoo (FI); Janne Tapio Kantola, Lempaala (FI); Erkko Anttila, Espoo (FI); Ville-Henrikki Vehkapera, Cupertino, CA (US)

(72) Inventors: Urho KONTTORI, Helsinki (FI); Petteri Kauhanen, Espoo (FI); Janne Tapio Kantola, Lempaala (FI); Erkko Anttila, Espoo (FI); Ville-Henrikki Vehkapera, Cupertino, CA (US)

(73) Assignee: Nokia Corporation

(21) Appl. No.: 13/474,253

(22) Filed: May 17, 2012

(51) Int. Cl. G06F 3/041

(52) U.S. Cl. 345/173

(57) ABSTRACT

Systems and techniques for controlling a device using contacts with a touch sensitive surface, with contacts being analyzed to determine if they represent incidental contacts or deliberate inputs. Upon recognition of a contact to a touch sensitive surface of a device, the contact is analyzed to determine if it meets at least one criterion for recognition as an input. Criteria may include location of the contact, as well as characteristics of the contact or a pattern of which the contact is a part. When a contact is recognized as indicating a deliberate input, user feedback may be provided, indicating to a user that the input was successful or allowing the user to be informed in time to abort or counteract the input.

### TECHNICAL FIELD

The present invention relates generally to user control of electronic devices. The invention also relates to mechanisms for providing assurance that a contact by a user indicates a deliberate input before taking action based on the input.

### BACKGROUND

Portable electronic devices, particular communication devices, are becoming more and more versatile. Devices can perform numerous functions and a user can provide inputs that will cause a device to take desired actions or change its behavior based on the inputs. For example, a user can adjust the volume of a device's sound playback, can skip forward or backward between audio tracks, can set a device to use or not use flash when in camera mode, can adjust camera parameters such as white balance or brightness, can cause the device to take a photograph, or cause the device to take any of numerous other actions or make any of numerous other adjustments.

It is desirable to make the control and adjustment of devices convenient for the user; it is also desirable to design controls so that the device does what the user wants it to do.

### SUMMARY

According to one embodiment of the invention, an apparatus comprises at least one processor and at least one memory storing computer program code. The at least one memory storing computer program code is configured to, with the at least one processor, cause the apparatus to perform actions comprising at least receiving information relating to at least one contact to a touch sensitive surface of the apparatus, analyzing the information to determine if the at least one contact represents an intention to provide at least one input to the apparatus, and, if the at least one contact represents an intention to provide at least one input to the apparatus, controlling the apparatus in accordance with the at least one input.

According to another embodiment of the invention, a method comprises receiving information relating to at least one contact to a touch sensitive surface of an apparatus, analyzing the information to determine if the at least one contact represents an intention to provide at least one input to the apparatus, and, if the at least one contact represents an intention to provide at least one input to the apparatus, controlling the apparatus in accordance with the at least one input.

According to another embodiment of the invention, a non-transitory computer readable medium stores computer-readable code. Execution of the computer-readable code by a processor configures an apparatus to perform actions comprising at least receiving information relating to at least one contact to a touch sensitive surface of the apparatus, analyzing the information to determine if the at least one contact represents an intention to provide at least one input to the apparatus, and, if the at least one contact represents an intention to provide at least one input to the apparatus, controlling the apparatus in accordance with the at least one input.

According to another embodiment of the present invention, a computer program product comprises a computer-readable medium bearing computer program code embodied therein for use with a computer. Execution of the computer program code causes actions comprising at least receiving information relating to at least one contact to a touch sensitive surface of an apparatus, analyzing the information to determine if the at least one contact represents an intention to provide at least one input to the apparatus, and, if the at least one contact represents an intention to provide at least one input to the apparatus, controlling the apparatus in accordance with the at least one input.

According to another embodiment of the invention, an apparatus comprises means for receiving information relating to at least one contact to a touch sensitive surface of the apparatus, means for analyzing the information to determine if the at least one contact represents an intention to provide at least one input to the apparatus, and means for, if the contact represents an intention to provide at least one input to the apparatus, controlling the apparatus in accordance with the at least one input.

### BRIEF DESCRIPTION OF THE DRAWINGS

FIG. 1 illustrates a user device according to an embodiment of the present invention;

FIG. 2 illustrates additional details of a user device according to an embodiment of the present invention;

FIGS. 3-7 illustrate various alternative configurations of a user device according to an embodiment of the present invention; and

FIG. 8 illustrates a process according to an embodiment of the present invention.

### DETAILED DESCRIPTION

Embodiments of the present invention recognize that mechanical controls have long been used for innumerable devices, but that mechanical controls are being supplemented and replaced by soft controls. Mechanical controls are controls that involve movement of an actuator, such as a switch, knob, or button, with the movement causing the device to behave in a predetermined way. A soft control may be defined as a control in which the response of the device to the same user action varies according to circumstances such as programming or an operating mode of the device. The term is frequently used to refer to user actions with a touch sensitive display screen of a device that can present different images to the user, such as icons for selection or images similar to mechanical controls, such as sliders or pushbuttons. In such cases, the response of the device to user actions may vary to adapt to the images that are being presented. The user action may be, for example, tapping an area of the display screen to select a function or sliding a finger along an area of the display screen to adjust a parameter such as playback volume. The actions to be taken upon recognition of a user action, and the areas of the display screen where a user input will be recognized, may change. For example the type of user action that will be recognized, and the effect that a user action will have, may depend on an operating mode of the device and on previous user actions. A device may respond to a wide variety of user actions, and a user may be able to scroll through numerous menu screens and make selections in successive screens to cause the device to respond in desired ways. In one example, the user may be presented with a selection of menu icons, one of which selects a music player function, and is actuated by a user touch. Once the selection has been made, the same portion of the display screen may present a pushbutton image, and touching of the pushbutton image may start music playback.

Soft controls are frequently implemented through user touches of a display screen, and such operation typically requires a user to be looking at the display screen of a device. Devices often have side controls that are adapted to be simple to operate so that a user can control the device without looking at it. For example, a device may have hardware controls such as slides, rocker switches, or pushbuttons on its side. It will be recognized that a device may also have hardware controls elsewhere. Such controls may allow a user to, start, stop, or pause sound playback, adjust playback volume, activate or deactivate a device feature, such as setting a flash to fire when a photograph is taken, or cause an action, such as the taking of a photograph. Adapting the design of the device so that some or all of these features were replaced with soft controls could offer a reduction in device cost and allow for a smoother external design, as well as reducing the amount of metal in the device and thus reducing interference with communication.

However, embodiments of the present invention also recognize that the mere holding and manipulation of a device involves touching the device, and that users will not wish to activate a function or make an adjustment every time they contact the side of the device. As used herein, “contact” may refer to either a direct contact or an approach of an object sufficiently close to a touch sensitive surface that the approach triggers recognition of a touch to the surface. For example, capacitive touch sensitive surfaces frequently recognize a touch when a user's finger or object is close to the surface but not actually touching the surface, and the term “contact” as used herein encompasses all situations in which a touch sensitive surface is activated in ways similar to those caused by a direct touch. Some contacts may be the result of deliberate user actions that should be interpreted as inputs, while other contacts may be merely incidental contacts associated with holding or manipulating the device.

Therefore, one or more embodiments of the present invention provide for mechanisms allowing a device to distinguish between an incidental side contact and a deliberate touch to the side of a device, directed toward activating a function. An incidental side contact may occur when a user picks up the device, while a deliberate touch is one where the user activates a control, such as by using a touch sensitive side control. A device may be configured to analyze at least one contact to determine if it represents an intention to provide at least one input to the device and controlling the device in accordance with the at least one input. For example, the at least one contact may comprise a specified sequence or combination of user actions, or one or more user actions having specified characteristics. A user action may comprise any user contact that can be detected by the device. An example of a user action may be a touch to a touch sensitive surface. Another example of a user action may be a placement of an object, such as a finger, in sufficiently close proximity of a touch sensitive surface that the proximity is detected, even if an actual touch does not occur. A user action may be simply incidental, and if a user action does not meet criteria for interpretation as an input, it may be ignored. If a user action meets specified criteria, it may be interpreted as directed toward an input. Examples of specified sequences and combinations of user actions may be a double touch in which two consecutive touches are made or a touch followed by a sliding action. User actions having specified characteristics may be, for example, a simultaneous touch with two fingers, a touch in a predetermined location, or a touch of more than a specified duration. It will be recognized that any list of example characteristics will not be exhaustive, and that any number of characteristics or combinations of characteristics may be used to indicate an intent to provide an input. Any single action or combination of actions on the part of the user may be recognized as indicating an intent to provide an input if the user action or combination of user actions meet specified criteria for indicating such an intent. If a contact or contacts do not meet such criteria, they will have no effect.

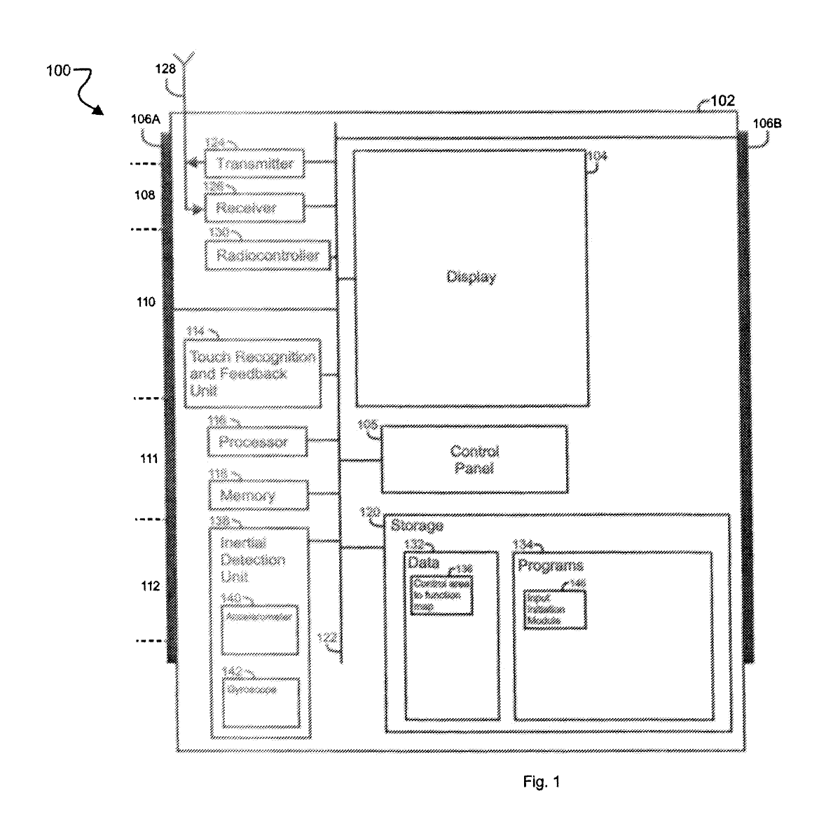

FIG. 1 illustrates a user device which may be a user equipment (UE) 100, configured to operate in a wireless communication system. It will, however, be recognized that embodiments of the present invention may be used in numerous types of devices, such as music and video players, cameras, game controllers, and many other types of devices.

The UE 100 comprises a case 102, housing a display 104 and various controls such as a front control panel 105 and one or more side control surfaces such as a side control surface 106A on the left side of the case 102 and a side control surface 106B on the right side of the case 102. The side control surfaces 106A and 106B may be touch sensitive surfaces, and in other embodiments of the invention, more than one side control surface may be present, or a side control surface may extend completely around the case 102. In the exemplary embodiment illustrated here, the side control surface 106A is divided into three areas—a press control area 108, a slide control area 110, and a custom control area 111. The side control surface 106A may also comprise an activation area 112, which may receive inputs, discussed in greater detail below, to direct a general activation of the side control surface 106A. The side control surfaces 106A and 106B may be connected to a touch recognition and feedback unit 114, which detects contacts of the side control surfaces 106A and 106B, recognizing the particular area of contact. The touch recognition and feedback unit 114 may also provide feedback, such as haptic feedback in the form of vibration. The UE 100 further comprises a processor 116, memory 118, and storage 120, communicating with one another over a bus 122. The UE 100 also includes a transmitter 124, receiver 126, antenna 128, and radiocontroller 130. The UE 100 employs data 132 and programs 134, suitably residing in storage 130 and transferred to memory 118 as needed for use by the processor 116. The data 132 may include a control area to function map 136, which may be changed as needed if the UE 100 is reprogrammed or differently configured, and may also be adaptable to map different functions to particular control areas depending on the particular mode of operation of the UE 100. For example, if the UE 100 is operating in a music player mode, the sliding of a user's finger in the slide control area 110 may be recognized and used to control playback volume, while if the UE 100 is operating in a camera mode, movement over the slide control area may be recognized as controlling exposure levels or zoom. If the UE is operating in a basic menu selection mode, a press in the press control area 108 may be recognized as activating a shutdown and mode change selector, where the user may choose, for example, between a silent mode, an airplane mode, and power off, while if the UE is operating in camera mode, recognition of a press in the press control area 108 may be used to initiate the taking of a photograph. Behavior of the custom control area 111 may be adapted based on an operating mode of the UE 100, or according to explicit user selections. For example, in one or more embodiments of the invention, operation of the UE 100 in a music playback mode may cause the custom control area 111 to respond to taps in specific portions of the custom control area by beginning or pausing playback or skipping forward or backward, and to long presses by fast forwarding or rewinding. Either or both of the side control surfaces 106A and 106B may be implemented as touch screen displays, so that icons representing the various functions may be presented, and may also include elements that a user can distinguish by feel, such as raised dots, lines, or shapes, to make operation of UE 100 easier when the user is not looking at it. As a further alternative, either or both of the side control surfaces 106A and 106B may simply be normal-appearing surfaces, but with sensing capabilities to detect touch input. In one or more alternative or additional embodiments, haptics may be used to create user-detectible features, such as bumps, on the side surfaces 106A and 106B.

A device such as the UE 100 may be configured to include either or both of the side surfaces 106A and 106B, and each of the surfaces 106A and 106B may be configured as desired. In the present exemplary embodiment, the side control surface 106B is configured so as to be used in conjunction with the side control surface 106A, so that the UE 100 performs an action when a specific contact is made with both of the surfaces 106A and 106B at the same time.

In addition to recognizing inputs by interpreting actions relating to side control surfaces such as the surfaces 106A and 106B, the UE may be controlled through different actions, such as actions involving movement or orientation of the device as a whole. Therefore the UE 100 also includes an inertial detection unit 138, which may include components such as an accelerometer 140 or gyroscope 142.

When the user is handling the UE 100, he or she will typically contact its edges, so that many contacts by the user will not represent an intentional input, and recognizing all contacts as inputs will cause errors. Therefore, among the programs 134 may be an input initiation module 146, which receives information provided by the touch recognition and feedback unit and analyzes such information to determine if it conforms to criteria indicating that a user touch or combination of touches represents an indication that a deliberate user input is intended. It will be recognized that the use of a specific input initiation module 146 is exemplary only, and that numerous alternative approaches exist for configuring a device to recognize a contact to a surface of the device and to determine both that the contact is to be interpreted as a control input to the device and how the device is to respond to the input.

When a user input is recognized, the input initiation module 146 may direct the touch recognition and feedback unit to provide feedback to the user indicating that an intention of a user input has been recognized. In one or more embodiments of the invention, the input initiation module 146 may simply place the UE 100 into an input mode, in which case subsequent touches will be recognized as inputs. In other embodiments of the invention, a sequence of touches may indicate that a specific input is being performed. Depending on the specific design and configuration of the device, the sequence of touches may be interpreted as indicating an input only if the sequence occurs in a specified activation area, or may be interpreted as indicating an input no matter where the sequence of touches may occur. For example, in an embodiment of the invention, a user may take a photograph by touching the press control area 108 with a finger, holding the finger in place, and pressing the finger further. When the initial touch and hold is recognized as a stage in taking a photograph, the touch recognition and feedback unit may vibrate the area to indicate that the input has been recognized. A continuation of the user action will result in taking of the photograph, with a further feedback provided to indicate that the user action has been completed. In one or more embodiments of the invention, the side control surface 106A may be sensitive to variations in pressure, or the UE 100 may provide other mechanisms to determine differences in pressure, so that an intention to perform a user action may be recognized only if an increase in pressure is detected. If the user does not wish to take a photograph, the initial feedback serves as a warning to the user, and the user can remove his or her finger, so that the photograph will not be taken.

Another exemplary mechanism for initiation of an input is a special sliding action, such as a two-finger sliding action. Such a user action may be used, for example, to initiate or carry out a sliding input, and may be particularly suitable for use with the slide control area 110. An incidental sliding user action is more likely to be performed with only one finger, while a sliding user action with two fingers is more likely to be deliberate, so that the input initiation module may more safely recognize the two-finger slide as indicating an intended input. To provide greater assurance, feedback may be provided as soon as the sliding action begins, so that if the user action is not intended, the user will be warned and can stop the user action. In other alternatives, a sliding user action may be recognized only if a specified minimum separation between fingers is detected, or if the fingers are initially slid in opposite directions.

Another exemplary mechanism may be tapping with two fingers, or tapping twice with two fingers. Such an approach may be useful, for example, in cases in which the custom control area 111 is configured to provide controls for a music player mode. For example, if a song is already playing, it might be paused only by a tap with two fingers in the “pause” area. Such an approach avoids stopping a song whenever the user handles the device—for example, to check the time.

Recognition of specific touch patterns as indicating inputs might be restricted to specific areas of the side control surface 106A—for example, the touch and press might have an effect only in the area 108, the two finger slide might have an effect only in the area 110, and the tap with two fingers might have an effect only in the custom control area 111. Alternatively, restrictions might be imposed based on the specific operating mode of the device, with combinations of touches having effect in different areas based on the operating mode, or with combinations of touches having an effect when the LIE 100 is operating in one mode or having no effect when the UE 100 is operating in a different mode. In one or more embodiments of the invention, the specific user action may be recognized based on the nature of the user actions no matter where on the side control surface 106A the action may be performed. For example, the touch and press anywhere on the side control surface 106A might have one effect, the two finger slide anywhere on the side control surface 106A might have a different effect, and the tap with two fingers anywhere on the side control surface 106A might have yet another effect.

The activation area 112 may be used to recognize an input or input combination intended to activate the other control areas, such as the areas 108, 110, and 111. For example, a user may hold one finger or, if the UE 100 is so configured, two fingers, on the activation area. The touch recognition and feedback unit provides feedback indicating that recognition of an intention to activate the areas 108, 110, and 111 has been accomplished, and thereafter inputs in the areas 108, 110, and 111 will be recognized without a need to use a special combination or sequence. Such behavior may be maintained so long as the user's finger or fingers are in place in the activation area 112, and when the finger or fingers are removed, the UE 100 will again require special combinations or sequences to recognize inputs in the areas 108, 110, and 111. It will, however, be recognized that an activation area such as the activation area 112 is optional and not required. As noted above, special combinations or sequences of user actions may cause recognition of a deliberate user input, and a device such as the UE 100 may be designed and configured so that all user inputs are recognized based on characteristics of the sequences or patterns of contacts that are to be recognized as inputs.

In another embodiment of the invention, both of the side control surfaces 106A and 106B may be involved a combination of user actions recognized as an input. For example, the UE 100 may be in a locked state in which it does not respond to touches to either of the side control surfaces 106A or 106B, and a user may unlock the device by a sliding motion along each of the side control surfaces 106A and 106B simultaneously.

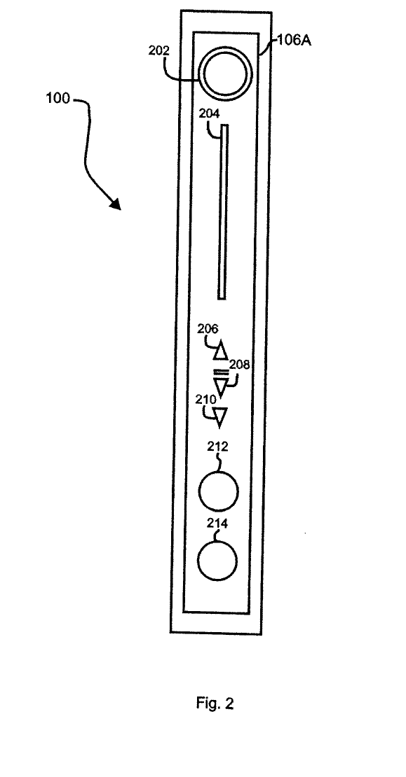

A control area designated for a specific type of control, such as a touch and press or a slide control, may include physical indications, such as texture, or a bump, to allow easy finger positioning when the user is not looking at the UE 100. FIG. 2 therefore illustrates a side view of the UE 100 and showing the side control surface 106A. FIG. 2 illustrates a raised circle 202 reminiscent of a button in the area 108, a raised ridge 204 forming a track for sliding in the area 110, and raised arrows 206 and 208 and a square 210 in the custom control area 111, reminiscent of music player controls. These or similar physical characteristics of the side control surface 106A allow a user to recognize the action that is to be performed and the type of touch that is needed to provide the proper input. The side control surface 106A also includes the activation area 112, which may include a distinctive feature such as a pair of indentations 212 and 214. The user can rest his or her fingers in the indentations 212 and 214 to activate the other control areas without a need for special action in those areas.

The design presented in FIG. 2 is exemplary, and numerous other approaches to design of the physical surface of the UE 100 are possible. The physical surface of the UE 100 may, for example be more generic than that presented in FIG. 2, and the control mechanisms provided by the different areas of the UE 100 may vary widely depending on factors such as the operating mode of the UE 100. In one or more embodiments, physical features of the side control surface 106A may be more generic than illustrated in FIG. 2. For example, physical features may be provided that divide the side control surface 106A into regions, with the side control surface 106A being implemented as a touch screen display that presents icons appropriate to the functions that may be invoked by user inputs in the different regions. In a further alternative embodiment, the side control surface may simply be a smooth surface and the user's familiarity with the UE 100 may be depended on for correct contact with the side surface 106A. In another alternative embodiment, haptic mechanisms may be used to create variable detectable features of the side surface 106A.

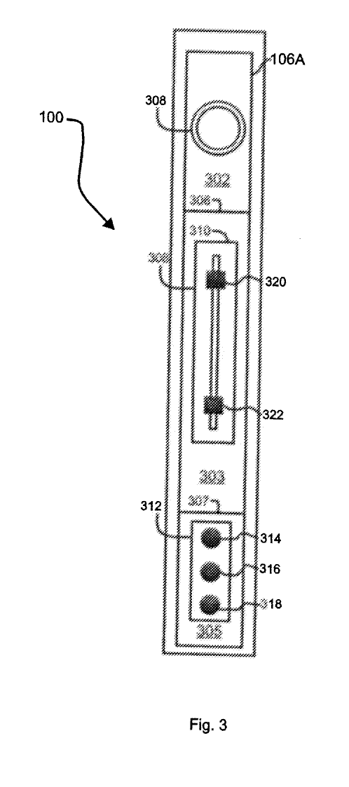

FIG. 3 illustrates an alternative configuration of the UE 100, showing the side surface 106A with features separating regions 302, 303, and 305. In the present exemplary embodiment, the features are physical features of the side surface 106A, and may conveniently be raised ridges 306 and 307. In the present embodiment, the UE 100 is in a camera operating mode, and the side surface 106A is operating as a touch screen display, presenting icons indicating their associated functions. The icons include a shutter release icon 308 for taking a picture, a double slider 310 for zoom, and a three-button selector 312 for controlling flash, with a button 314 for always off, a button 316 for auto, and a button 318 for always on. To take a photograph, the user may press and hold the shutter release icon 308, or may press and then exert further pressure. To zoom, the user may use a pinch zoom, which will be recognized as a deliberate input because it involves a two finger action. The user may touch slider icons 320 and 322 and slide them inward or outward on a track 321, to indicate tightening or widening the field of view. The user may double-tap on a desired one of the buttons 314, 316, and 318. The embodiment illustrated in FIG. 3 does not use an activation area such as the activation area 112 of FIGS. 1 and 2, but instead recognizes contacts as inputs when they conform to criteria such as those described above.

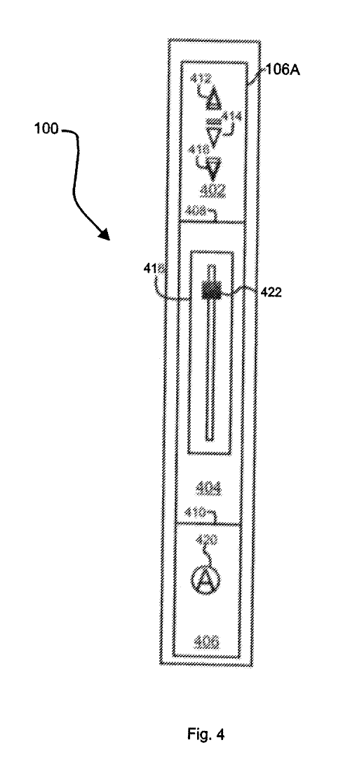

FIG. 4 illustrates a further alternative configuration of the UE 100, showing the side surface 106A with the UE configured to operate in a music player mode. The side surface 106A comprises regions 402, 404, and 406, with raised ridges 408 and 410 providing separation between regions. The side surface presents rewind/skip back, play/pause, and fast forward/skip forward button icons 412, 414, and 416, a volume control slider 418, and an activation icon 420. In one embodiment of the invention, the user may double tap on the buttons 408, 410, and 412, and may hold a slider icon 422 until feedback is received and then slide the slider icon 422 in one direction or another to increase or decrease playback volume. Alternatively, the user may activate the functions indicated by the icons while maintaining contact with the activation icon 420. While contact is maintained with the activation icon 420, user contact with the icons 408, 410, 412, and 416 may be recognized as inputs without a need to use special patterns.

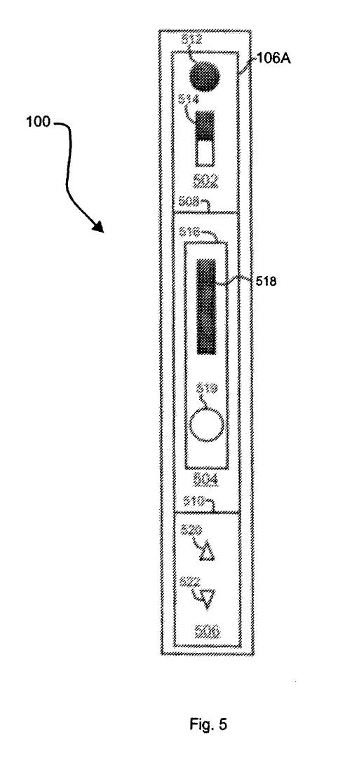

FIG. 5 illustrates the UE 100, showing the side surface 106A configured for general device control. Regions 502, 504, and 506 can be seen, separated by ridges 508 and 510. The side surface 106A under the configuration illustrated here provides mechanisms for controlling the device display to save power, locking the device to prevent inadvertent activation, and scrolling or paging through a device display. Illustrated in the region 502 are icons representing a button 512 for toggling the device display on and off, a two-position switch 514 for locking and unlocking the device, that is, for enabling or disabling device controls. The button 512 and the switch 514 may suitably be activated with a double touch or a touch and hold.

A user may lock the device by activating one side of the switch icon 514, and may unlock the device by activating the other side of the switch 514. With the device locked, user inputs other than unlocking the device will not be recognized. Illustrated in the region 504 is a scroll device 516, for scrolling the device display up or down. The scroll device 516 may comprise a scroll wheel icon 518 and an activation icon 519, with the activation icon 519 allowing the user to maintain contact with the icon 519 and activate the scroll wheel icon 518 without special patterns or sequences. The region 506 includes page up and page down icons 520 and 522 for moving through the display one page at a time, and may be activated with a double touch or a touch and hold.

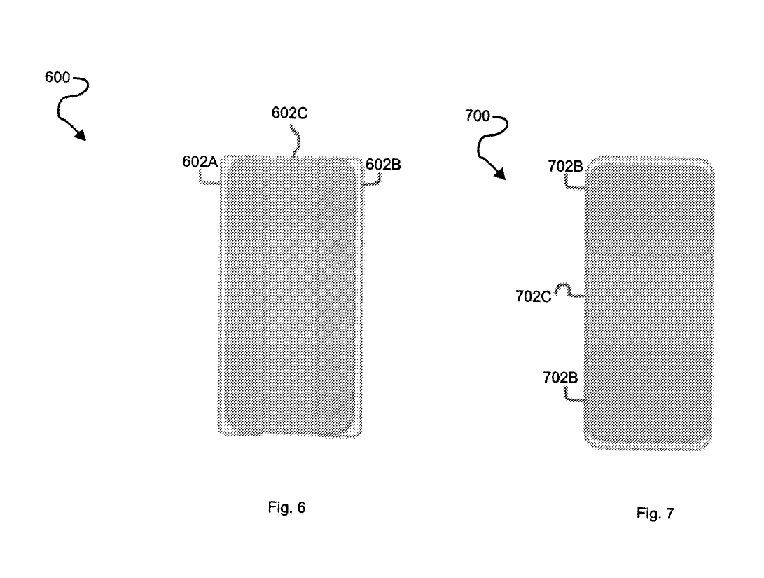

FIGS. 6 and 7 illustrate UEs 600 and 700, respectively, according to alternative embodiments of the invention. Each of the UEs 600 and 700 may include an inertial detection unit similar to the unit 138 of FIG. 1, allowing recognition of actions causing motion of the UE. For example, the UE 600 may implement volume control by recognizing taps to the area 602A as increasing volume and to the area 602B as decreasing volume. Recognition of taps as increasing or decreasing volume may, for example, follow a specified action such as a double tap to the area 602C. The specified action may be recognized as activating volume control for a specified time, and such recognition and activation may be indicated by a sound or haptic feedback, with deactivation occurring if no taps are recognized during the specified time, and the deactivation being indicated by a further sound or haptic feedback. The UE 700 may operate in a similar way to that of the UE 700, with taps to the areas 702A and 702B increasing and decreasing volume and the double tap to the area 702C causing activation of the volume control.

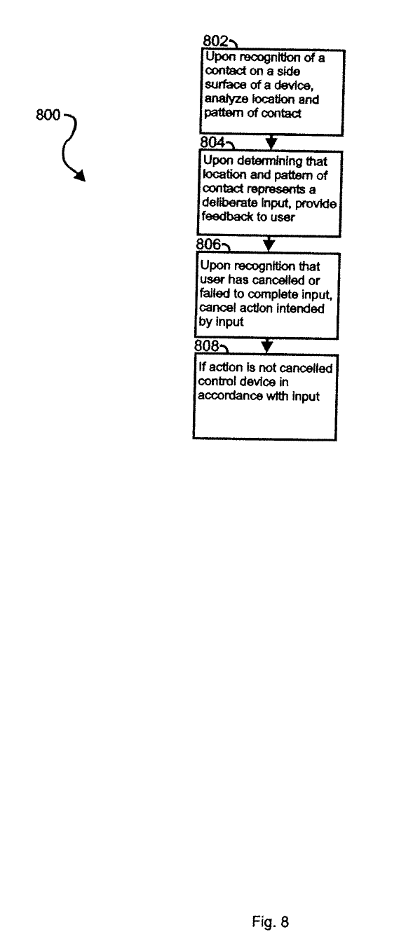

FIG. 8 illustrates a process 800 according to an embodiment of the present invention. At step 802, upon recognition of a contact on a side surface of a device, the location and pattern of the contact is analyzed to determine if it meets criteria associated with a deliberate input intended to cause a response by the device, such as changing modes of operation or performing a function. Analysis may suitably take into account the number and location of contacts, the duration of contacts, whether the contacts occur in a particular sequence. At step 804, upon determination that the location and pattern of the contact represents a deliberate input, feedback, such as in the form of a vibration, is provided to the user. The contact may be one input in a succession of inputs, so that if the user fails to make a succeeding input, the action indicated by the succession of inputs will not be taken. In additional or alternative approaches, the user may have the opportunity to cancel an action before it is taken. Therefore, at step 806, upon recognition that a user has cancelled an input or failed to complete an input or succession of inputs, the action intended by the input is cancelled. At step 808, if the action is not cancelled, the device is controlled in accordance with the input.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

1. An apparatus comprising:
at least one processor;
at least one memory storing computer program code;
wherein the at least one memory storing computer program code is configured to, with the at least one processor, cause the apparatus to perform actions comprising at least:
receiving information relating to at least one contact to a touch sensitive surface of the apparatus;
analyzing the information to determine if the at least one contact represents an intention to provide at least one input to the apparatus; and
if the at least one contact represents an intention to provide at least one input to the apparatus, controlling the apparatus in accordance with the at least one input.

2. The apparatus of claim 1, wherein analyzing the information comprises determining that the at least one contact comprises a specified sequence of user actions.

3. The apparatus of claim 2, wherein the specified sequence of user actions comprises an initial contact followed by an additional user action.

4. The apparatus of claim 3, wherein the specified sequence of user actions comprises an initial contact followed by an additional exertion of pressure.

5. The apparatus of claim 3, wherein the specified sequence of user actions comprises a contact of more than a specified duration.

6. The apparatus of claim 1, wherein the analyzing the information comprises determining that the at least one contact occurred in a specified area of the touch sensitive surface.

7. The apparatus of claim 1, wherein analyzing the information comprises determining that the at least one contact occurs while the apparatus is in an operating mode such that all contacts to specified areas of the touch sensitive surface are recognized as inputs.

8-10. (canceled)

11. A method comprising:
receiving information relating to at least one contact to a touch sensitive surface of an apparatus;
analyzing the information to determine if the at least one contact represents an intention to provide at least one input to the apparatus; and
if the at least one contact represents an intention to provide at least one input to the device, controlling the device in accordance with the at least one input.

12. The method of claim 11, wherein analyzing the information comprises determining that the at least one contact comprises a specified sequence of user actions.

13-15. (canceled)

16. The method of claim 11, wherein the analyzing the information comprises determining that the at least one contact occurred in a specified area of the touch sensitive surface.

17. The method of claim 11, wherein analyzing the information comprises determining that the at least one contact occurs while the apparatus is in an operating mode such that all contacts to specified portions of the touch sensitive surface are recognized as inputs.

18. The method of claim 11, wherein analyzing the information comprises recognizing of multiple simultaneous contacts in a specified area.

19. The method of claim 11, wherein the actions further comprise providing user feedback upon determining that the at least one contact meets the at least one criterion for recognition as an input.

20. The method of claim 11, wherein controlling the device in accordance with the at least one input comprises recognizing at least one contact as enabling recognition of inputs and directing action by the device in response to at least one user action recognized as an input.

21. A non-transitory computer readable medium storing computer-readable code, execution of which by a processor configures an apparatus to perform actions comprising at least:
receiving information relating to at least one contact to a touch sensitive surface of the apparatus;
analyzing the information to determine if the at least one contact represents an intention to provide at least one input to the apparatus; and
if the at least one contact represents an intention to provide at least one input to the apparatus, controlling the apparatus in accordance with the at least one input.

22. The computer readable medium of claim 21, wherein analyzing the information comprises determining that the at least one contact comprises a specified sequence of user actions.

23. The computer readable medium of claim 22, wherein the specified sequence of user actions comprises an initial contact followed by an additional user action.

24. The computer readable medium of claim 23, wherein the specified sequence of user actions comprises an initial contact followed by an additional exertion of pressure.

25. The computer readable medium of claim 23, wherein the specified sequence of user actions comprises a contact of more than a specified duration.

26. The computer readable medium of claim 21, wherein the analyzing the information comprises determining that the at least one contact occurred in a specified area of the touch sensitive surface.

27-30. (canceled)
